(19) United States
(12) Patent Application Publication
(10) Pub. No.: US 2020/0273084 A1
(43) Pub. Date: Aug. 27, 2020

(54) AUGMENTED-REALITY FLIGHT-VIEWING SUBSYSTEM

(71) Applicant: App in the Air, Inc., Bellevue, WA (US)

(72) Inventors: Bayram Annakov, Seattle, WA (US); Sergey Pronin, Miusinsk (RU)

(73) Assignee: App in the Air, Inc., Bellevue, WA (US)

(21) Appl. No.: 16/794,700

(22) Filed: Feb. 19, 2020

Related U.S. Application Data
(60) Provisional application No. 62/808,628, filed on Feb. 21, 2019.

(51) Int. Cl. G06Q 30/06; G06Q 10/02; G06T 19/00; G06Q 50/30

(52) U.S. Cl. CPC G06Q 30/0631; G06Q 50/30; G06T 19/006; G06Q 10/02

(57) ABSTRACT

The current document is directed to methods and systems that provide an automated augmented-reality facility for viewing airline trips. In one implementation, a virtual image of a world globe is displayed to a user, via an augmented-reality method, on a user device that includes a camera, within an electronic image of the real scene encompassed by the field of view of the camera. The user's flights are displayed as arcs connecting flight starting and ending points. The user can rotate the world globe to view flights, spin the world globe continuously, reorient and rescale the world globe, and move around in real space to view the virtual world globe from different perspectives.

### CROSS-REFERENCE TO RELATED APPLICATION

This application claims the benefit of Provisional Application No. 62/808,628, filed Feb. 21, 2019.

### TECHNICAL FIELD

The current document is directed to is directed to automated airline-flight-reservation systems and, in particular, to methods and subsystems that provide, to users, an automated augmented-reality facility for viewing their airline trips.

### BACKGROUND

With the advent of the Internet and powerful personal processor-controlled computers, smart phones, and other computing devices, older methods for finding and booking flights, including in-person and telephone interactions with travel agents, have been largely supplanted by automated airline-flight-reservation Internet services. While, in many ways, these automated services are more convenient and time efficient, they generally fail to provide the personalized services that were previously provided as a result of long-term relationships between travel agents and their clients. Many of the automated airline-flight-reservation systems provide awkward and complex user interfaces, for example, and tend to provide a far greater number of flight selections and information than desired by users, who often would prefer to receive only a small number of flight selections that accurately reflect their preferences and who would often prefer not to be required to tediously input large numbers of parameters and invoke many different types of search filters in order to direct the automated airline-flight-reservation systems to search for desirable flights. For this reason, developers, owners and administrators, and users of automated airline-flight-reservation services continue to seek better, more effective, and more efficient implementations and user interfaces.

### SUMMARY

The current document is directed to methods and systems that provide an automated augmented-reality facility for viewing airline trips. In one implementation, a virtual image of a world globe is displayed to a user, via an augmented-reality method, on a user device that includes a camera, within an electronic image of the real scene encompassed by the field of view of the camera. The user's flights are displayed as arcs connecting flight starting and ending points. The user can rotate the world globe to view flights, spin the world globe continuously, reorient and rescale the world globe, and move around in real space to view the virtual world globe from different perspectives.

### BRIEF DESCRIPTION OF THE DRAWINGS

FIGS. 1A-D illustrate various types of three-dimensional models.

FIGS. 2A-B illustrate the relationship between a virtual-camera position and a three-dimensional model.

FIGS. 3A-D illustrate one approach to mapping points in the world coordinate system to corresponding points on the image plane of a virtual camera.

FIG. 4 illustrates an augmented-reality method that combines images of virtual objects with electronic images generated by a camera capturing light rays from a real scene.

FIGS. 5A-C illustrates one implementation of the currently disclosed augmented-reality flight-viewing subsystem.

FIGS. 6A-B provide control-flow diagrams that illustrate one implementation of the currently disclosed augmented-reality flight-viewing subsystem.

### DETAILED DESCRIPTION

The current document is directed to methods and subsystems that provide an automated augmented-reality facility for viewing a user's flights. These methods and subsystems are generally incorporated within an automated flight-recommendation-and-booking system that provides a variety of travel-related services.

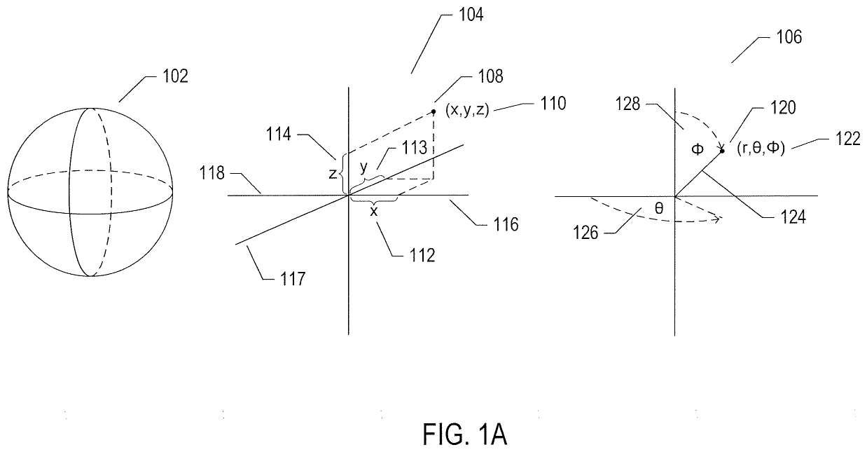

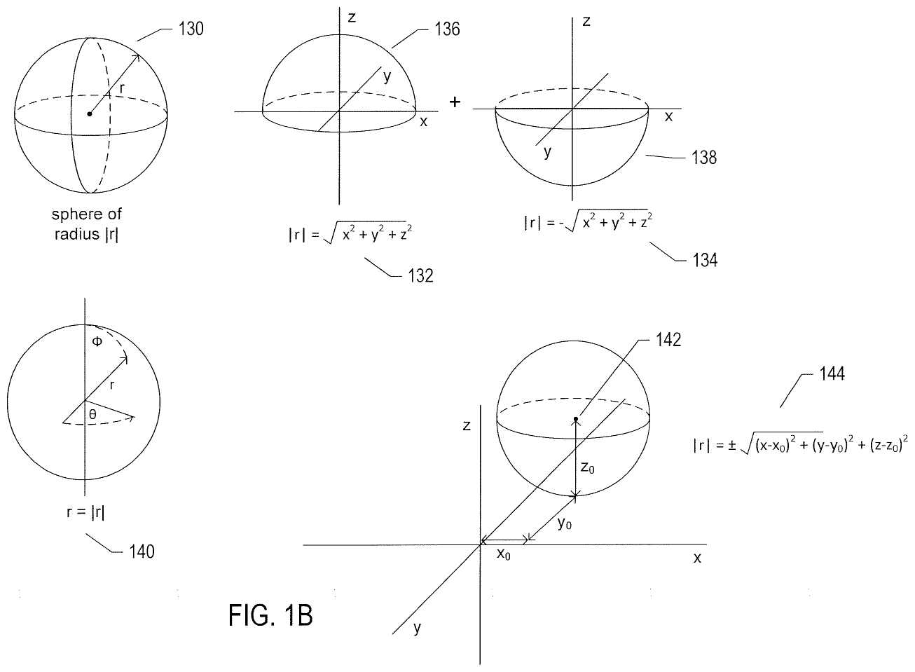

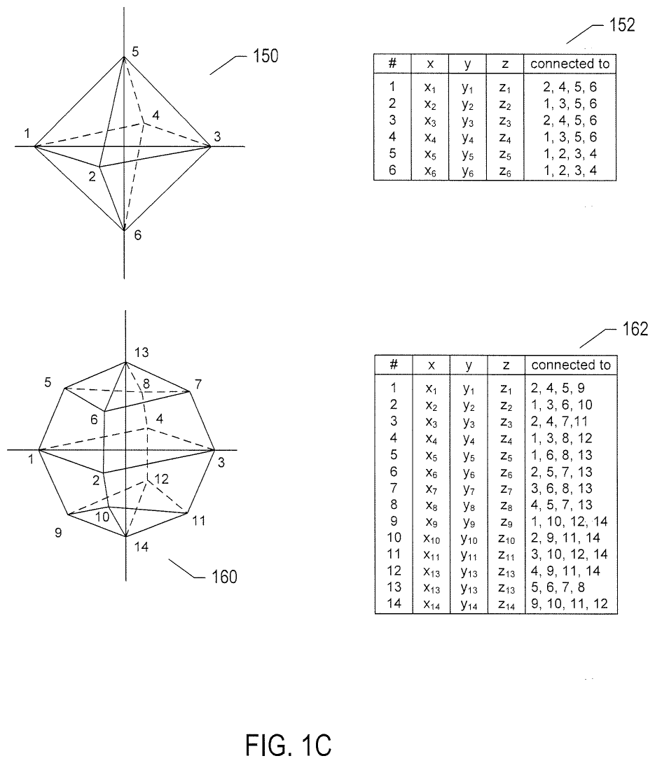

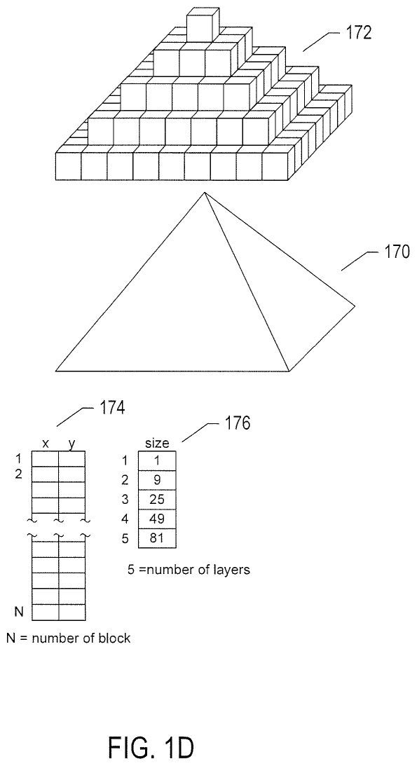

FIGS. 1A-D illustrate various types of three-dimensional models. In a first example, shown in FIGS. 1A-C, a sphere 102 is modeled. One approach to modeling a sphere is to use well-known analytical expressions for a sphere. This requires a coordinate system. Two common coordinate systems used for modeling include the familiar Cartesian coordinate system 104 and the spherical-coordinates coordinate system 106. In the Cartesian coordinate system, a point in space, such as point 108, is referred to by a triplet of coordinates (x, y, z) 110. The values of these coordinates represent displacements 112-114 along the three orthogonal coordinate axes 116-118. In the spherical-coordinates coordinate system, a point, such as point 120, is also represented by a triplet of coordinates (r, θ, φ) 122 that represent the magnitude of the vector 124 corresponding to the point and two angles θ 126 and φ 128 that represent the direction of the vector, as shown in FIG. 1A. As shown in FIG. 1B, a sphere of radius |r| 130 centered at the origin is described by two analytical expressions 132 and 134, in Cartesian coordinates, corresponding to the two half spheres 136 and 138, respectively. In spherical coordinates, the sphere is described by the simple expression 140. When the center of the sphere is located at a general position (x₀, y₀, z₀) 142, the sphere is described by the expression 144. There are many different ways to represent surfaces analytically.

While analytical expressions are available for certain surfaces in three dimensions, they are not available for many other surfaces and, even were they available, it is often more computationally efficient to represent complex surfaces by a set of points. As shown in FIG. 1C, a sphere may be crudely represented by six points 150 and the triangular surfaces that each have three of the six points as vertices. These triangular surfaces represent facets of an octahedron, in the current example. A point-based model may be represented by a table 152 that includes the coordinates for the points as well as an indication of the line-segment connections between the points. As greater numbers of points are used 160 and 162, better approximations of the sphere are obtained. As shown in FIG. 1D, another method that can be used to model three-dimensional objects is to construct the objects from smaller regular objects. For example, a three-dimensional pyramid 170 with a square base can be modeled from a collection of cubes 172. The collection of cubes can be represented by a table of coordinates of the center of the cubes 174 or, alternatively, by an indication of the number of square layers and their sizes, in cubes, assuming that they are centered along a comment axis 176. Many other types of models of three-dimensional objects can be used to represent three-dimensional objects, including mixed models that employ analytical expressions for portions of the surfaces of the object or a combination of analytical expressions, points, and collections of small, regular objects.

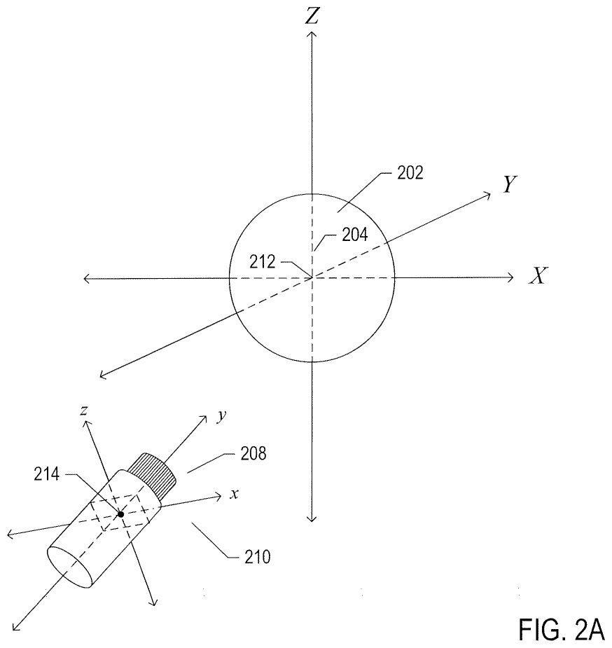

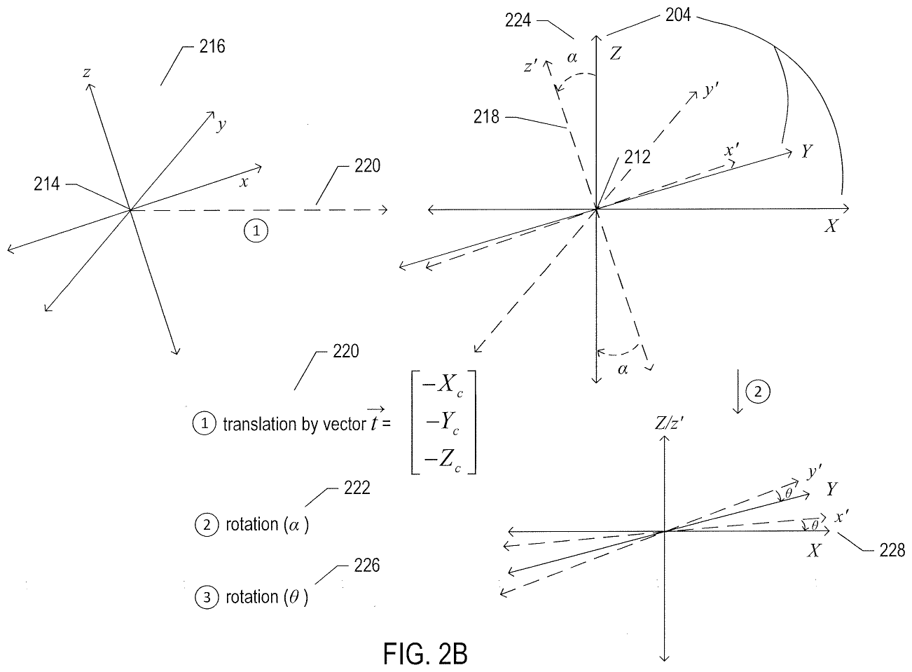

FIGS. 2A-B illustrate the relationship between a virtual-camera position and a three-dimensional model. As shown in FIG. 2A, the three-dimensional model of a sphere 202 is translationally and rotationally positioned within a three-dimensional world coordinate system 204 having three mutually orthogonal axes X, Y, and Z. A two-dimensional view of the three-dimensional model can be obtained, from any position within the world coordinate system external to the three-dimensional model, by simulated image capture using a virtual camera 208. The virtual camera 208 is associated with its own three-dimensional coordinate system 210 having three mutually orthogonal axes x, y, and z. The world coordinate system and the camera coordinate system are, of course, mathematically related by a translation of the origin of the camera x, y, z coordinate system from the origin 212 of the world coordinate system and by three rotation angles that, when applied to the camera, rotate the camera x, y, and z coordinate system with respect to the world X, Y, Z coordinate system. The origin 214 of the camera x, y, z coordinate system has the coordinates (0, 0, 0) in the camera coordinate system and the coordinates (X_{c}, Y_{c}, and Z_{c}) in the world coordinate system. The two-dimensional image captured by the virtual camera 216 can be thought of as lying in the x, z plane of the camera coordinate system and centered at the origin of the camera coordinate system, as shown in FIG. 2.

FIG. 2B illustrates operations involved with orienting and positioning the camera x, y, z coordinate system to be coincident with the world X, Y, Z coordinate system. In FIG. 2B, the camera coordinate system 216 and world coordinate system 204 are centered at two different origins, 214 and 212, respectively, and the camera coordinate system is oriented differently than the world coordinate system. In order to orient and position the camera x, y, z coordinate system to be coincident with the world X, Y, Z coordinate system, three operations are undertaken. A first operation 220 involves translation of the camera-coordinate system, by a displacement represented by a vector t, so that the origins 214 and 212 of the two coordinate systems are coincident. The position of the camera coordinate system with respect to the world coordinate system is shown with dashed lines, including dashed line 218, with respect to the world coordinate system following the translation operation 220. A second operation 222 involves rotating the camera coordinate system by an angle α (224) so that the z axis of the camera coordinate system, referred to as the z′ axis following the translation operation, is coincident with the Z axis of the world coordinate system. In a third operation 226, the camera coordinate system is rotated about the Z/z′ axis by an angle θ (228) so that all of the camera-coordinate-system axes are coincident with their corresponding world-coordinate-system axes.

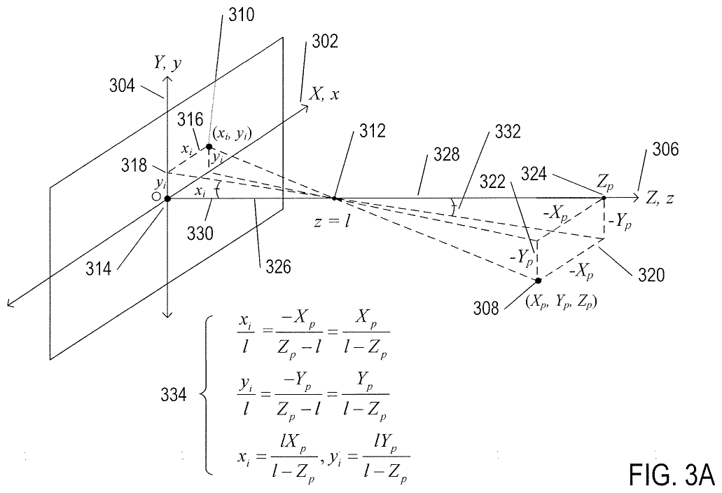

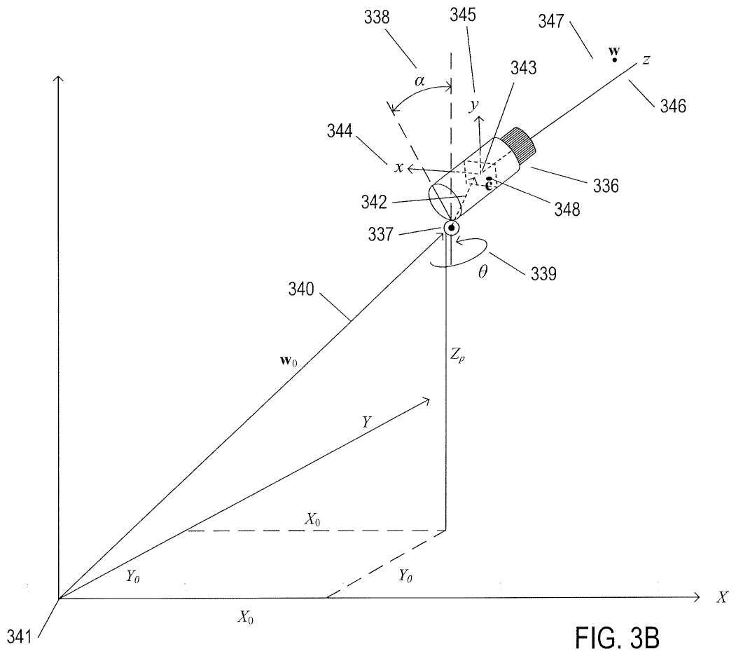

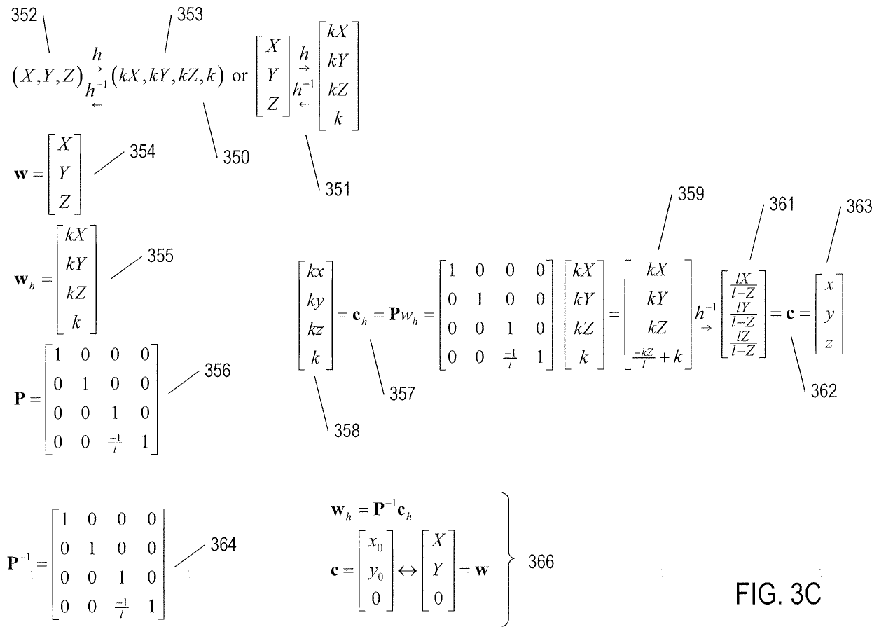

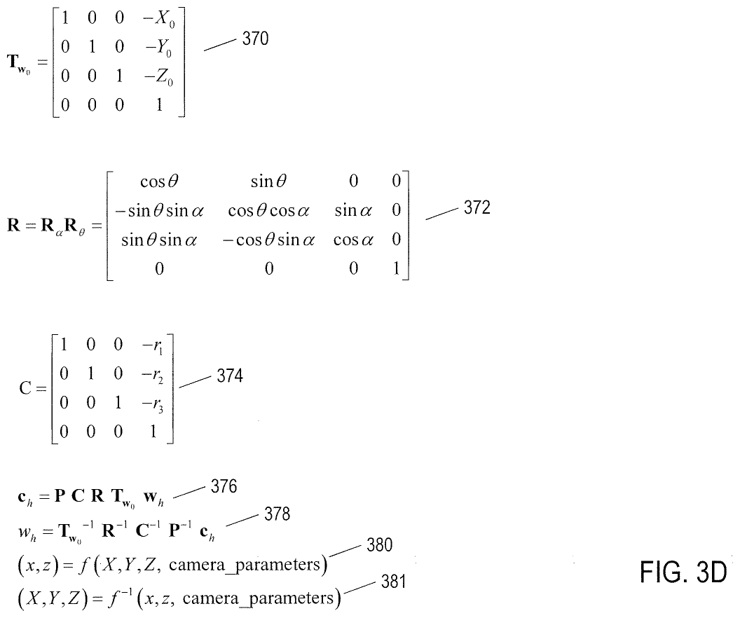

FIGS. 3A-D illustrate one approach to mapping points in the world coordinate system to corresponding points on the image plane of a virtual camera. This process allows virtual cameras to be positioned anywhere within space with respect to a computational three-dimensional model and used to generate a two-dimensional image that corresponds to the two-dimensional image that would be captured from a real camera having the same position and orientation with respect to an equivalent solid-model. FIG. 3A illustrates the image plane of a virtual camera, an aligned camera coordinate system and world coordinate system, and a point in three-dimensional space that is imaged on the image plane of the virtual camera. In FIG. 3A, and in FIGS. 3B-D that follow, the camera coordinate system, comprising the x, y, and z axes, is aligned and coincident with the world-coordinate system X, Y, and Z. This is indicated, in FIG. 3A, by dual labeling of the x and X axis 302, they and Y axis 304, and the z and Z axis 306. The point that is imaged 308 is shown to have the coordinates (Xₚ, Yₚ, and Zₚ). The image of this point on the virtual-camera image plane 310 has the coordinates (xᵢ, yᵢ). The virtual lens of the virtual camera is centered at the point 312, which has the camera coordinates (0, 0, l) and the world coordinates (0, 0, l). When the point 308 is in focus, the distance l between the origin 314 and point 312 is the focal length of the virtual camera. Note that, in FIG. 3A, the z axis is used as the axis of symmetry for the virtual camera rather than the y axis, as in FIG. 2A. A small rectangle is shown, on the image plane, with the corners along one diagonal coincident with the origin 314 and the point 310 with coordinates (xᵢ, yᵢ). The rectangle has horizontal sides, including horizontal side 316, of length xᵢ, and vertical sides, including vertical side 318, with lengths yᵢ. A corresponding rectangle with horizontal sides of length −Xₚ, including horizontal side 320, and vertical sides of length −Yₚ, including vertical side 322. The point 308 with world coordinates Xₚ, Yₚ, and Zₚ) and the point 324 with world coordinates (0, 0, Zₚ) are located at the corners of one diagonal of the corresponding rectangle. Note that the positions of the two rectangles are inverted through point 312. The length of the line segment 328 between point 312 and point 324 is Zₚ-l. The angles at which each of the lines passing through point 312 intersects the z, Z axis are equal on both sides of point 312. For example, angle 330 and angle 332 are identical. As a result, the principal of the correspondence between the lengths of similar sides of similar triangles can be used to derive expressions for the image-plane coordinates (xᵢ, yᵢ) for an imaged point in three-dimensional space with world coordinates (Xₚ, Yₚ, and Zₚ) 334:

$$\frac{{x}_{i}}{l} = \frac{- {X}_{p}}{{Z}_{p} - l} = \frac{{X}_{p}}{l - {Z}_{p}} \\ \frac{{y}_{i}}{l} = \frac{- {Y}_{p}}{{Z}_{p} - l} = \frac{{Y}_{p}}{l - {Z}_{p}}$$

$${x}_{i} = \frac{l {X}_{p}}{l - {Z}_{p}} , {y}_{i} = \frac{{lY}_{p}}{l - {Z}_{p}}$$

Of course, virtual-camera coordinate systems are not, in general, aligned with the world coordinate system, as discussed above with reference to FIG. 2A. Therefore, a slightly more complex analysis is required to develop the functions, or processes, that map points in three-dimensional space to points on the image plane of a virtual camera. FIGS. 3B-D illustrate the process for computing the image of points in a three-dimensional space on the image plane of an arbitrarily oriented and positioned virtual camera. FIG. 3B shows the arbitrarily positioned and oriented virtual camera. The virtual camera 336 is mounted to a mount 337 that allows the virtual camera to be tilted by an angle α 338 with respect to the vertical Z axis and to be rotated by an angle θ 339 about a vertical axis. The mount 337 can be positioned anywhere in three-dimensional space, with the position represented by a position vector w₀ 340 from the origin of the world coordinate system 341 to the mount 337. A second vector r 342 represents the relative position of the center of the image plane 343 within the virtual camera 336 with respect to the mount 337. The orientation and position of the origin of the camera coordinate system coincides with the center of the image plane 343 within the virtual camera 336. The image plane 343 lies within the x, y plane of the camera coordinate axes 344-346. The camera is shown, in FIG. 3B, imaging a point w 347, with the image of the point w appearing as image point c 348 on the image plane 343 within the virtual camera. The vector w₀ that defines the position of the camera mount 337 is shown, in FIG. 3B, to be the vector

$${w}_{0} = [ \begin{matrix}{X}_{0} \\ {Y}_{0} \\ {Z}_{0}\end{matrix} ]$$

FIGS. 3C-D show the process by which the coordinates of a point in three-dimensional space, such as the point corresponding to vector w in world-coordinate-system coordinates, is mapped to the image plane of an arbitrarily positioned and oriented virtual camera. First, a transformation between world coordinates and homogeneous coordinates h and the inverse transformation h⁻¹ is shown in FIG. 3C by the expressions 350 and 351. The forward transformation from world coordinates 352 to homogeneous coordinates 353 involves multiplying each of the coordinate components by an arbitrary constant k and adding a fourth coordinate component k. The vector w corresponding to the point 347 in three-dimensional space imaged by the virtual camera is expressed as a column vector, as shown in expression 354 in FIG. 3C. The corresponding column vector wₕ in homogeneous coordinates is shown in expression 355. The matrix P is the perspective transformation matrix, shown in expression 356 in FIG. 3C. The perspective transformation matrix is used to carry out the world-to-camera coordinate transformations (334 in FIG. 3A) discussed above with reference to FIG. 3A. The homogeneous-coordinate-form of the vector c corresponding to the image 348 of point 347, cₕ, is computed by the left-hand multiplication of wₕ by the perspective transformation matrix, as shown in expression 357 in FIG. 3C. Thus, the expression for cₕ in homogeneous camera coordinates 358 corresponds to the homogeneous expression for cₕ in world coordinates 359. The inverse homogeneous-coordinate transformation 360 is used to transform the latter into a vector expression in world coordinates 361 for the vector c 362. Comparing the camera-coordinate expression 363 for vector c with the world-coordinate expression for the same vector 361 reveals that the camera coordinates are related to the world coordinates by the transformations (334 in FIG. 3A) discussed above with reference to FIG. 3A. The inverse of the perspective transformation matrix, P⁻¹, is shown in expression 364 in FIG. 3C. The inverse perspective transformation matrix can be used to compute the world-coordinate point in three-dimensional space corresponding to an image point expressed in camera coordinates, as indicated by expression 366 in FIG. 3C. Note that, in general, the Z coordinate for the three-dimensional point imaged by the virtual camera is not recovered by the perspective transformation. This is because all of the points in front of the virtual camera along the line from the image point to the imaged point are mapped to the image point. Additional information is needed to determine the Z coordinate for three-dimensional points imaged by the virtual camera, such as depth information obtained from a set of stereo images or depth information obtained by a separate depth sensor.

Three additional matrices are shown in FIG. 3D that represent the position and orientation of the virtual camera in the world coordinate system. The translation matrix T_{w}_{₀} 370 represents the translation of the camera mount (337 in FIG. 3B) from its position in three-dimensional space to the origin (341 in FIG. 3B) of the world coordinate system. The matrix R represents the α and θ rotations needed to align the camera coordinate system with the world coordinate system 372. The translation matrix C 374 represents translation of the image plane of the virtual camera from the camera mount (337 in FIG. 3B) to the image plane's position within the virtual camera represented by vector r (342 in FIG. 3B). The full expression for transforming the vector for a point in three-dimensional space wₕ into a vector that represents the position of the image point on the virtual-camera image plane cₕ is provided as expression 376 in FIG. 3D. The vector wₕ is multiplied, from the left, first by the translation matrix 370 to produce a first intermediate result, the first intermediate result is multiplied, from the left, by the matrix R to produce a second intermediate result, the second intermediate result is multiplied, from the left, by the matrix C to produce a third intermediate result, and the third intermediate result is multiplied, from the left, by the perspective transformation matrix P to produce the vector cₕ. Expression 378 shows the inverse transformation. Thus, in general, there is a forward transformation from world-coordinate points to image points 380 and, when sufficient information is available, an inverse transformation 381. It is the forward transformation 380 that is used to generate two-dimensional images from a three-dimensional model or object corresponding to arbitrarily oriented and positioned virtual cameras. Each point on the surface of the three-dimensional object or model is transformed by forward transformation 380 to points on the image plane of the virtual camera.

Thus, by the methods discussed above, it is possible to generate an image of an object that would be obtained by a camera positioned at a particular position relative to the object. This is true for a real object as well as a representation of a real object, such as any of the representations discussed above with reference to FIGS. 1A-D.

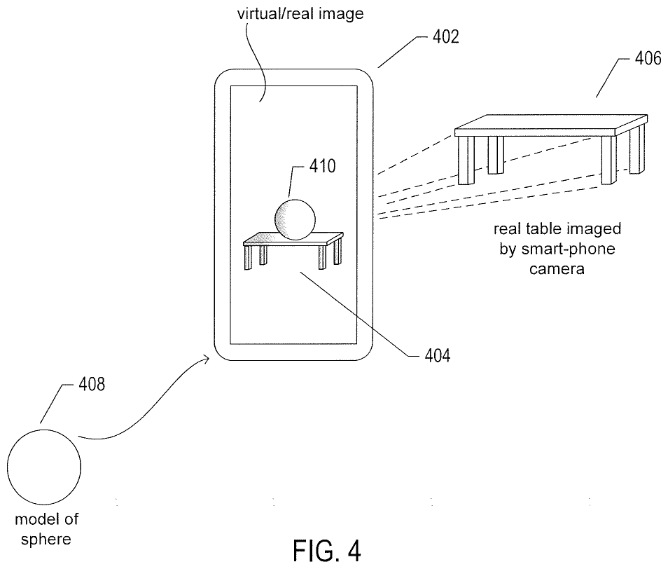

FIG. 4 illustrates an augmented-reality method that combines images of virtual objects with electronic images generated by a camera capturing light rays from a real scene. In the example shown in FIG. 4, a camera-equipped device, such as a smart phone 402, can be controlled to display an electronic image of a real object 406 in the field of view of the camera. In addition, the camera-equipped device can be controlled to generate an image of an object 408 represented by a model, such as those discussed above with reference to FIGS. 1A-D, assuming that the object is positioned at a particular point in the real space that is currently being imaged by the camera. For example, as shown in FIG. 4, the modeled sphere is considered to be positioned at the center of the table 406, and so a virtual image of the sphere is generated, by the methods discussed above with reference to FIGS. 2A-3D, and incorporated into the displayed image so that it appears that the sphere is resting at the center of the table 410. Thus, the augmented-reality method provides a part real, part virtual image of a scene that can be viewed by a user as if the user were viewing an actual scene through the camera incorporated in the camera-equipped device.

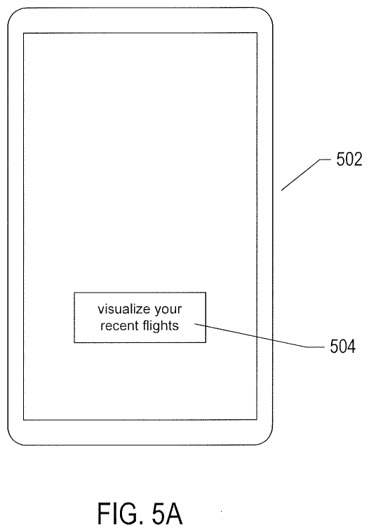

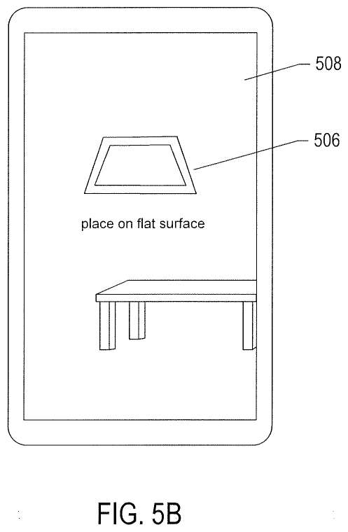

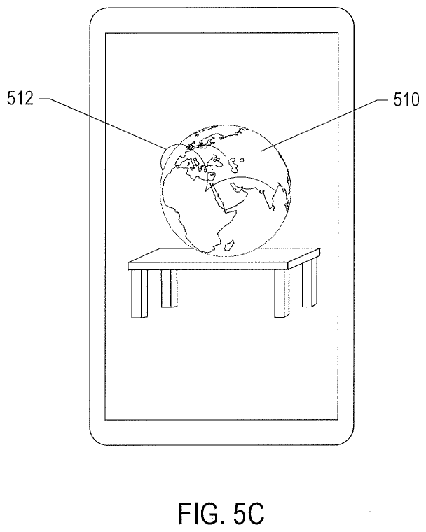

FIGS. 5A-C illustrates one implementation of the currently disclosed augmented-reality flight-viewing subsystem. The augmented-reality flight-viewing subsystem is generally a subsystem of an automated flight-recommendation-and-booking system. A user of the automated flight-recommendation-and-booking system, when wishing to view the flight or flights he or she has made during some interval of time, can invoke the augmented-reality flight-viewing subsystem to view a virtual image of a world globe annotated with arcs representing the flight or flights. In various different implementations, the user may select a set of flights to view based on any of various different criteria, including time frames, airlines, the regions, and other criteria. In certain implementations, multiple users can view and compare their flights via a distributed, peer-to-peer augmented-reality flight-viewing subsystem. The user initially invokes the augmented-reality flight-viewing subsystem, using a personal device, such as a smart phone 502, as shown in FIG. 5A, by input to a flight-viewing-subsystem launching feature 504. The augmented-reality flight-viewing subsystem, as shown in FIG. 5B, switches on the camera of the personal device and overlays a graphic 506, using the above-discussed augmented-reality method, on the electronic image 508 of the scene currently being captured by the personal-device camera. The graphic 506 represents a request for the user to translate and orient the phone in three-dimensional space so that the graphic corresponds to a relatively flat surface. Then, as shown in FIG. 5C, the augmented-reality flight-viewing subsystem generates a virtual image of a world globe 510 annotated with arcs, such as arc 512, representing each of the user's flights. The world globe is displayed at a position selected by positioning of the graphic 506, as discussed above with reference to FIG. 5B. In certain implementations, the augmented-reality flight-viewing subsystem may display a flight-selection menu to allow the user to select subsets of the user's flights prior to switching on the camera and displaying the graphic 506. The virtual image of the world globe 510 may spin, to provide viewing from different perspectives. Various types of user input may increase or decrease the rate of spin, stop spinning of the globe, start spinning of the globe, reorient the world globe, rescale the world globe, alter the flight display by changing colors and thicknesses of the arcs, deleting and adding flights, and may effect various other changes to the augmented-reality display. Of course, the augmented-reality flight-viewing subsystem continuously recomputes and redisplays the annotated world globe to reflect changes in position and orientation of the user device.

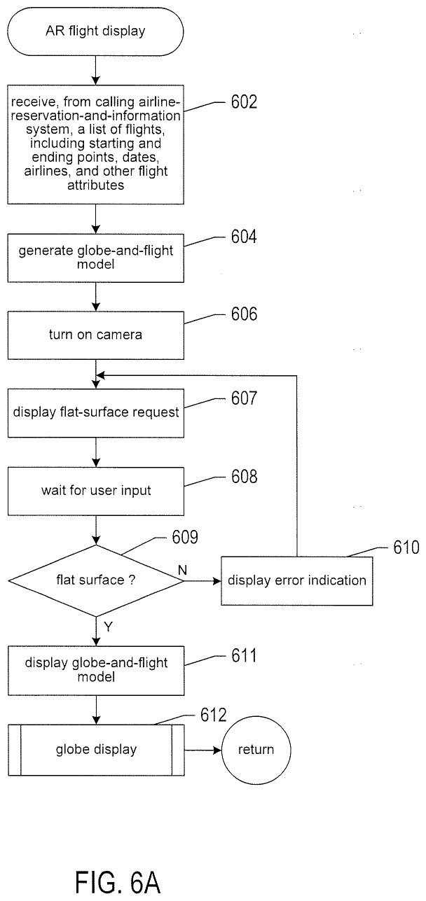

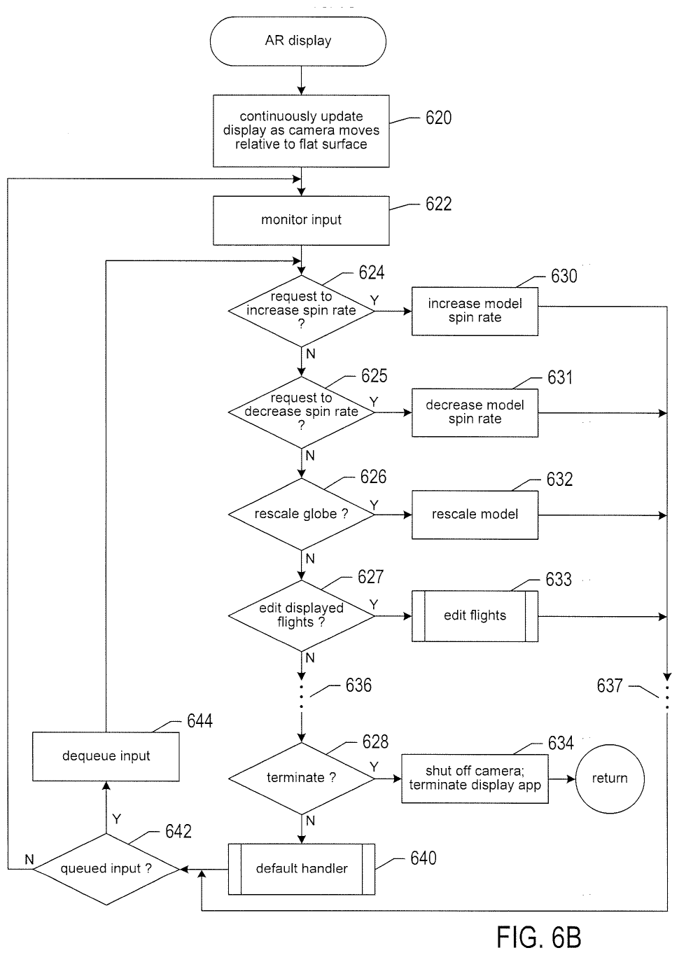

FIGS. 6A-B provide control-flow diagrams that illustrate one implementation of the currently disclosed augmented-reality flight-viewing subsystem. FIG. 6A provides a control-flow diagram of the high-level routine “AR Flight Display.” In step 602, the routine receives, from a calling airline-reservation-and-information system, a list of flights to display, each listed flight including starting and ending points and, in certain implementations, other attributes, including dates, airlines, and other such information which may be additionally displayed as annotations to the virtual image of the world globe. In step 604, the routine accesses a three-dimensional model of the world globe and adds the arc annotations and other annotations to the model. In step 606, the routine turns on the user-device camera. In step 607, the routine displays the graphic (506 in FIG. 5B) that requests the user to position the camera so that the graphic corresponds to a relatively flat surface. In step 608, the routine waits for user input. If the selected position does not appear to be a flat surface, based on distance-to-surface measurements made by the user device, as determined in step 609, the routine displays an error message, in step 610, and control returns to step 607. Otherwise, in step 611, the routine displays the virtual image of the annotated world globe in the electronic display on the flat surface selected by the user. In step 612, the routine calls the routine “globe display” to continuously update the display as the camera moves relative to the selected flat surface and to respond to user input to adjust the display, as discussed above. The user can move the camera about the real space while continuing to produce a realistic augmented-reality scene.

FIG. 6B provides a control-flow diagram for the routine “globe display,” called in step 611 of FIG. 6A. In step 620, the routine “globe display” continuously updates the display, as discussed above. The routine “globe display” concurrently monitors the device for user input, in step 622. When user input occurs, the routine “globe display” determines, through a series of conditional steps 624-628, what action the user is requesting and then carries out that action in one of steps 630-634. Ellipses 636 and 637 indicate that many additional types of actions may be requested by a user, various different implementations. A default handler 640n handles rare and/or unexpected inputs and events. When there are additional inputs queued for processing, as determined in step 642, a next input is dequeued in step 44 and handled by return of control to step 624. Otherwise, control returns to step 622.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems can be obtained by varying any of many different design and implementation parameters, including modular organization, programming language, underlying operating system, control structures, data structures, and other such design and implementation parameters. As discussed above, many additional features may be included in the augmented-reality flight-display subsystem to allow users to concurrently view flight displays together, change the appearance and content of the flight displays, and carry out various additional types of activities with respect to the flight display.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated flight-recommendation-and-booking system comprising:
electronically stored information about flights, airlines, and other information relevant to air travel;
a flight-recommendation-and-booking subsystem, implemented within a cloud-computing facility, data center, or one or more Internet-connected servers; and
an augmented-reality flight-viewing subsystem that displays a virtual image of a world globe annotated with flight information.

2. The automated flight-recommendation-and-booking system of claim 1 wherein the virtual image of the world globe annotated with flight information is annotated with arcs representing flights made by a client of the automated flight-recommendation-and-booking system.

3. The automated flight-recommendation-and-booking system of claim 2 wherein the virtual image of a world globe annotated with flight information can be controlled, through input to the augmented-reality flight-viewing subsystem, to spin in a selected direction.

4. The automated flight-recommendation-and-booking system of claim 2 wherein the flight-information annotation can be controlled, through input to the augmented-reality flight-viewing subsystem, to
change display colors of the arcs;
change display thickness of the arcs;
deleting arcs;
adding arcs by selecting additional flights for display; and
adding additional alphanumeric annotations.

5. The automated flight-recommendation-and-booking system of claim 2 wherein display of the virtual image of a world globe annotated with flight information can be altered, through input to the augmented-reality flight-viewing subsystem, alterations including:
reorienting the virtual image of the world globe;
resealing the virtual image of the world globe; and
changing a rate of spin.

6. The automated flight-recommendation-and-booking system of claim 1 wherein the augmented-reality flight-viewing subsystem is implemented in a smart phone.

7. The automated flight-recommendation-and-booking system of claim 1 wherein the smart phone
renders the virtual image of the world globe annotated with flight information from a world-globe model stored in a memory within the smart phone and flight information transmitted to the smart phone by the flight-recommendation-and-booking subsystem; and
incorporates the virtual image of the world globe annotated with flight information in an electronically displayed representation of a scene within a field of view of a camera within the smart phone, so that the virtual image of the world globe annotated with flight information appears to be located at a position within the scene within the field of view of the camera.

8. The automated flight-recommendation-and-booking system of claim 1 wherein the smart phone initially positions the virtual image of the world globe annotated with flight information within the scene within the field of view of the camera by displaying a graphic for positioning within the scene within the field of view of the camera by translating and orienting the smart phone.

9. The automated flight-recommendation-and-booking system of claim 1 wherein the smart phone maintains the apparent location of the virtual image of the world globe annotated with flight information in three-dimensional space as the smart phone is subsequently reoriented and translated in three-dimensional space.

10. The automated flight-recommendation-and-booking system of claim 1 wherein input to the smart phone selects a set of flights for annotation of the virtual image of the world globe based on any of various different criteria, including time frames, airlines, geographical regions, and other criteria.

11. The automated flight-recommendation-and-booking system of claim 1 wherein multiple users can view and compare their flights via a distributed, peer-to-peer augmented-reality flight-information information subsystem.

12. A method that displays flight information, the method comprising:
receiving flight information, including starting and ending points of one or more flights;
accessing a world-globe model;
rendering a virtual image of the world globe annotated with flight information;
incorporating the virtual image of the world globe annotated with flight information in an electronically displayed representation of a scene within a field of view of a camera, so that the virtual image of the world globe annotated with flight information appears to be located at a position within the scene within the field of view of the camera; and
responding to input directives to alter display of the virtual image of the world globe annotated with flight information.

13. The method of claim 12 wherein the virtual image of the world globe annotated with flight information is annotated with arcs representing flights.

14. The method of claim 13 wherein the input directives include input directives to spin the virtual image of the world globe annotated with flight information in a selected direction.

15. The method of claim 13 wherein the input directives include input directives to
change display colors of the arcs;
change display thickness of the arcs;
deleting arcs;
adding arcs by selecting additional flights for display; and
adding additional alphanumeric annotations.

16. The method of claim 13 wherein input directives include input directives to
reorient the virtual image of the world globe;
rescale the virtual image of the world globe; and
change a rate of spin of the virtual image of the world globe.

17. The method of claim 13 implemented in a smart phone.

18. The method of claim 17 wherein the smart phone communicates with a flight-recommendation-and-booking subsystem of an automated flight-recommendation-and-booking system to receive the flight information.

19. A data-storage device encoded with processor instructions that, when executed by one or more processors of a processor-controlled device, control the processor-controlled device to:
receive flight information, including starting and ending points of one or more flights;
access a world-globe model;
render a virtual image of the world globe annotated with flight information;
incorporate the virtual image of the world globe annotated with flight information in an electronically displayed representation of a scene within a field of view of a camera, so that the virtual image of the world globe annotated with flight information appears to be located at a position within the scene within the field of view of the camera; and
respond to input directives to alter display of the virtual image of the world globe annotated with flight information.
